(19) United States
(12) Patent Application Publication
(10) Pub. No.: US 2009/0179158 A1
(43) Pub. Date: Jul. 16, 2009

(54) IN-VACUUM PROTECTIVE LINERS

(75) Inventors: Lyudmila Stone, Lynnfield, MA (US); Julian G. Blake, Gloucester, MA (US); Dale K. Stone, Lynnfield, MA (US); Ron S. Serisky, Melrose, MA (US)

Correspondence Address: VARIAN SEMICONDUCTOR EQUIPMENT ASSC., INC., 35 DORY RD., GLOUCESTER, MA, 01930-2297, US

(73) Assignee: VARIAN SEMICONDUCTOR EQUPIMENT ASSOCIATE, INC., Gloucester, MA (US)

(21) Appl. No.: 12/353,642

(22) Filed: Jan. 14, 2009

Related U.S. Application Data
(60) Provisional application No. 61/021,486, filed on Jan. 16, 2008.

(51) Int. Cl. H01J 27/00; G21K 1/00; H01J 49/00

(52) U.S. Cl. 250/423 R; 250/424; 250/505.1; 250/281

(57) ABSTRACT

This device has a liner disposed on a face in a vacuum chamber. A component in the vacuum chamber defines the face. The liner is configured to protect the workpiece from contamination or to prevent blistering of the face caused by implantation of atoms or ions into the face. The liner may be disposable and removed from the face in the vacuum chamber and replaced with a new liner in some embodiments. This liner may be a polymer with a roughened surface, be carbon-based, or be composed of carbon nanotubes in some embodiments.

### CROSS-REFERENCE TO RELATED APPLICATIONS

This application claims priority to the provisional patent application entitled “In-Vacuum Protective Liners,” filed Jan. 16, 2008 and assigned U.S. application No. 61/021,486, which is hereby incorporated by reference.

### FIELD

This invention relates to liners, and, more particularly, to liners configured to protect a workpiece or faces in a workpiece processing tool.

### BACKGROUND

Ion implantation is a standard technique for introducing conductivity-altering impurities into workpieces, such as, for example, semiconductor wafers. During implantation or other workpiece processing, particles may be generated. For example, the implantation process generates undesired material that may coat the interior of an ion implanter or plasma treatment device. First, accelerated ions will sputter materials off any impinged surface. These sputtered materials will deposit on surrounding surfaces, including the workpiece. These materials may contaminate the workpiece. Second, byproducts of implantation, such as photoresist outgassing, or other particles that exist in an ion implanter or plasma treatment device also may deposit on surrounding surfaces, form a film, and eventually flake off. This causes further particle contamination within the ion implanter or plasma treatment device and may contaminate the workpiece. Third, atoms or ions such as hydrogen, helium, nitrogen, or oxygen may implant a surface and cause blistering. Fourth, the interior of an ion implanter or plasma treatment device, even while at vacuum, still will contain some particles. Accelerated ions may strike these particles, ionizing them. Recently ionized particles may then strike the surfaces in an ion implanter or plasma treatment device, causing sputtering and, consequently, metal contamination. These particles also may build up and deposit and flake off, causing further contamination.

Such undesired material within an ion implanter or plasma treatment device has required preventative maintenance such as scraping the inner walls or the cleaning of entire parts or units. One previous method of protecting an ion implanter has been to use silicon-coated aluminum inserts. Some of these inserts were also plasma-sprayed. These inserts are not flexible, are expensive, are difficult to clean, and are difficult to position within an ion implanter.

Another previous method protected a flexible bellows from undesired material with a flexible liner. These flexible bellows liners typically needed to have a high temperature resistance, which is less applicable with chamber walls and adds cost to the flexible bellows liner.

Yet another previous method mounted controlled-temperature inserts to the walls of an ion implanter. This method required a means to control the temperature and also required a heater to be bonded to the inserts. This sort of insert is expensive and not disposable. It also increased the heat load on a workpiece or other workpiece handling components.

Accordingly, there is a need in the art for a liner that overcomes the above-described inadequacies and shortcomings.

### SUMMARY

According to a first aspect of the invention, an apparatus is provided. The apparatus comprises an ion generation device configured to generate ions; a vacuum chamber; a component in the vacuum chamber defining a face; a workpiece; and a platen configured to support the workpiece for treatment by the ions. A liner is disposed on the face to protect the workpiece from contamination. The liner has a roughened surface and is selected from the group consisting of KAPTON, polyetheretherketone, polytetrafluoroethylene, perfluoroalkoxy, perfluoroalkoxyethylene, parylene, VESPEL, and UPILEX.

According to a second aspect of the invention, an apparatus is provided. The apparatus comprises an ion generation device configured to generate ions; a vacuum chamber; a component in the vacuum chamber defining a face; a workpiece; and a platen configured to support the workpiece for treatment by the ions. A liner is disposed on the face. The liner is composed of carbon and is configured to prevent blistering of the face due to implantation of ions into the face.

According to a third aspect of the invention, a method is provided. The method comprises providing a liner disposed on a face in a device configured to generate ions. The ions are directed toward a workpiece. Particles are generated with the ions and the particles strike the liner. Particles are retained on the liner or blistering of the face due to implantation of the particles is prevented.

### BRIEF DESCRIPTION OF THE DRAWINGS

For a better understanding of the present disclosure, reference is made to the accompanying drawings, which are incorporated herein by reference and in which:

FIG. 1 is a block diagram of a beam-line ion implanter;

FIG. 2 is a block diagram of a plasma doping system;

FIG. 3 is a cross-sectional view of one embodiment of a liner;

FIG. 4 is a cross-sectional view of an embodiment of the liner in FIG. 3 being impacted by particles;

FIG. 5 is a cross-sectional view of another embodiment of a liner;

FIG. 6 is a cut-away perspective view of liners in a vacuum chamber;

FIG. 7 is a block diagram of liners in a beam-line ion implanter;

FIG. 8 is a cross-sectional view of an embodiment of liners on a workpiece holding apparatus; and

FIG. 9 is a block diagram of liners in a plasma doping system.

### DETAILED DESCRIPTION

The liners are described herein in connection with a beam-line ion implanter and a plasma doping system. However, the liners can be used with other systems and processes involved in semiconductor manufacturing, other systems and processes involved in plasma treatment, or other systems and processes that use accelerated ions. Thus, the invention is not limited to the specific embodiments described below.

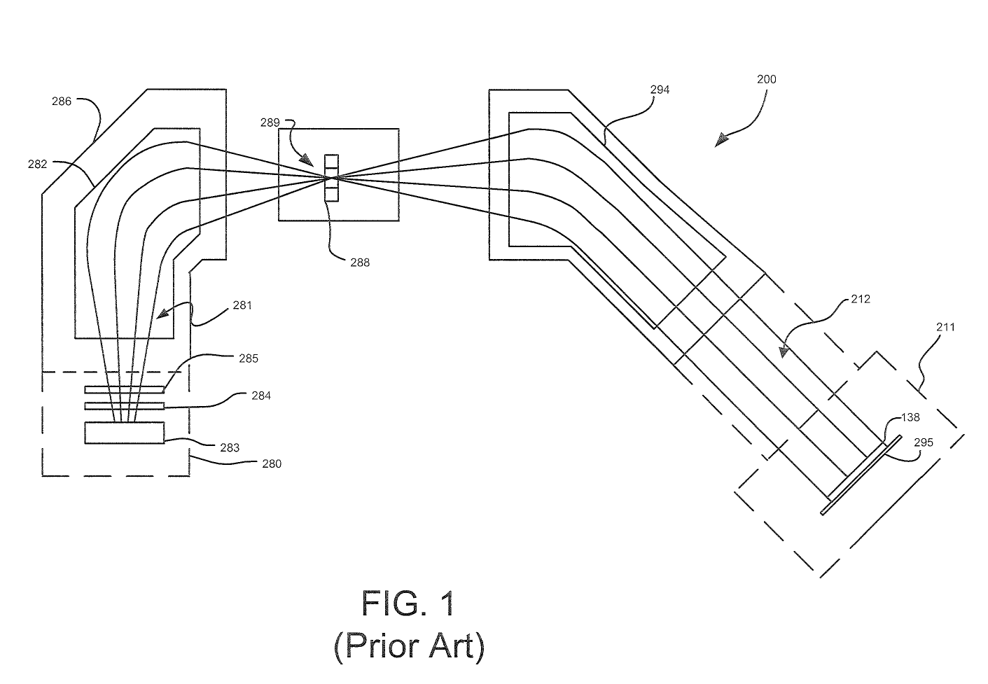

Turning to FIG. 1, a block diagram of a beam-line ion implanter 200 that may provide ions for treating a selected material is illustrated. Those skilled in the art will recognize that the beam-line ion implanter 200 is only one of many examples of beam-line ion implanters that can provide ions for doping a selected material.

In general, the beam-line ion implanter 200 includes an ion source 280 to generate ions that form an ion beam 281. The ion source 280 may include an ion chamber 283 and a gas box containing a gas to be ionized. The gas is supplied to the ion chamber 283 where the gas is ionized. This gas may be or may include, in some embodiments, As, B, P, H, N, O, He, carborane C₂B₁₀H₁₂, another large molecular compound, or another noble gas. The ions thus formed are extracted from the ion chamber 283 to form the ion beam 281. The ion beam 281 is directed between the poles of resolving magnet 282. A power supply is connected to an extraction electrode of the ion source 280 and provides an adjustable voltage.

The ion beam 281 passes through a suppression electrode 284 and a ground electrode 285 to a mass analyzer 286. The mass analyzer 286 includes a resolving magnet 282 and a masking electrode 288 having a resolving aperture 289. The resolving magnet 282 deflects ions in the ion beam 281 such that ions of a desired ion species pass through the resolving aperture 289. Undesired ion species do not pass through the resolving aperture 289, but are blocked by the masking electrode 288.

Ions of the desired ion species pass through the resolving aperture 289 to the angle corrector magnet 294. The angle corrector magnet 294 deflects ions of the desired ion species and converts the ion beam from a diverging ion beam to a ribbon ion beam 212, which has substantially parallel ion trajectories. The beam-line ion implanter 200 may further include acceleration or deceleration units in some embodiments.

An end station 211 supports one or more workpieces, such as workpiece 138, in the path of the ribbon ion beam 212 such that ions of the desired species are implanted into the workpiece 138. The end station 211 may include a platen 295 to support the workpiece 138. The end station 211 also may include a scanner (not shown) for moving the workpiece 138 perpendicular to the long dimension of the ribbon ion beam 212 cross-section, thereby distributing ions over the entire surface of workpiece 138. Although the ribbon ion beam 212 is illustrated, other embodiments may provide a spot beam.

The ion implanter may include additional components known to those skilled in the art. For example, the end station 211 typically includes automated workpiece handling equipment for introducing workpieces into the beam-line ion implanter 200 and for removing workpieces after ion implantation. The end station 211 also may include a dose measuring system, an electron flood gun, or other known components. It will be understood to those skilled in the art that the entire path traversed by the ion beam is evacuated during ion implantation. The beam-line ion implanter 200 may incorporate hot or cold implantation of ions in some embodiments.

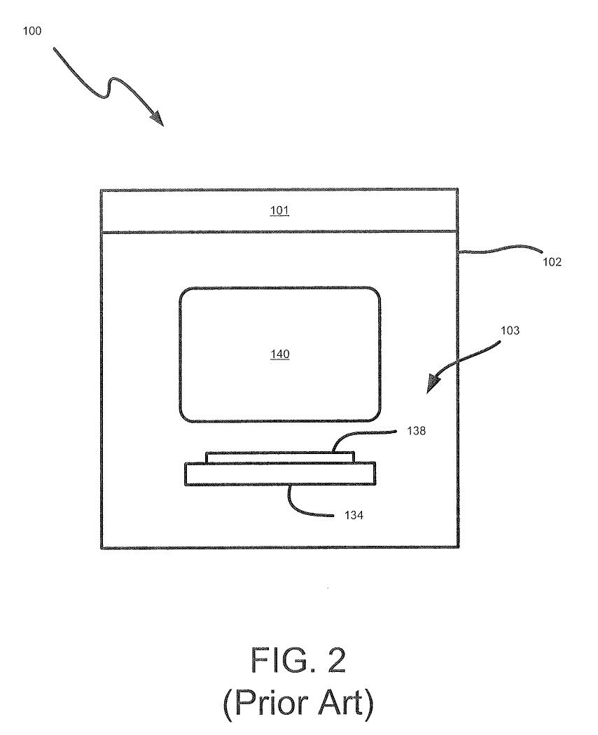

Turning to FIG. 2, the plasma doping system 100 includes a process chamber 102 defining an enclosed volume 103. A platen 134 may be positioned in the process chamber 102 to support a workpiece 138. The platen 134 may be biased using a DC or RF power supply. The platen 134, workpiece 138, or process chamber 102 may be cooled or heated by a temperature regulation system (not illustrated). In one instance, the workpiece 138 may be a semiconductor wafer having a disk shape, such as, in one embodiment, a 300 mm diameter silicon wafer. However, the workpiece 138 is not limited to a silicon wafer. The workpiece 138 could also be, for example, a flat panel, solar, or polymer substrate. The workpiece 138 may be clamped to a flat surface of the platen 134 by electrostatic or mechanical forces. In one embodiment, the platen 134 may include conductive pins (not shown) for making connection to the workpiece 138. The plasma doping system 100 further includes a source 101 configured to generate a plasma 140 within the process chamber 102. The source 101 may be an RF source or other sources known to those skilled in the art. The plasma doping system 100 may further include a shield ring, a Faraday sensor, or other components. In some embodiments, the plasma doping system 100 is part of a cluster tool, or operatively-linked plasma doping chambers within a single plasma doping system 100. Thus, numerous plasma doping chambers may be linked in vacuum.

In operation, the source 101 is configured to generate the plasma 140 within the process chamber 102. In one embodiment, the source is an RF source that resonates RF currents in at least one RF antenna to produce an oscillating magnetic field. The oscillating magnetic field induces RF currents into the process chamber 102. The RF currents in the process chamber 102 excite and ionize a gas to generate the plasma 140. The bias provided to the platen 134, and, hence, the workpiece 138, will accelerate ions from the plasma 140 toward the workpiece 138 during bias pulse on periods. The frequency of the pulsed platen signal and/or the duty cycle of the pulses may be selected to provide a desired dose rate. The amplitude of the pulsed platen signal may be selected to provide a desired energy. With all other parameters being equal, a greater energy will result in a greater implanted depth.

One skilled in the art will recognize other systems and processes involved in semiconductor manufacturing, other systems and processes involved in plasma treatment, or other systems and processes that use accelerated ions that may incorporate embodiments of the liners disclosed herein besides the beam-line ion implanter 200 or the plasma doping system 100. Some examples of these include, for example, plasma etching tools, CVD tools, or PVD tools.

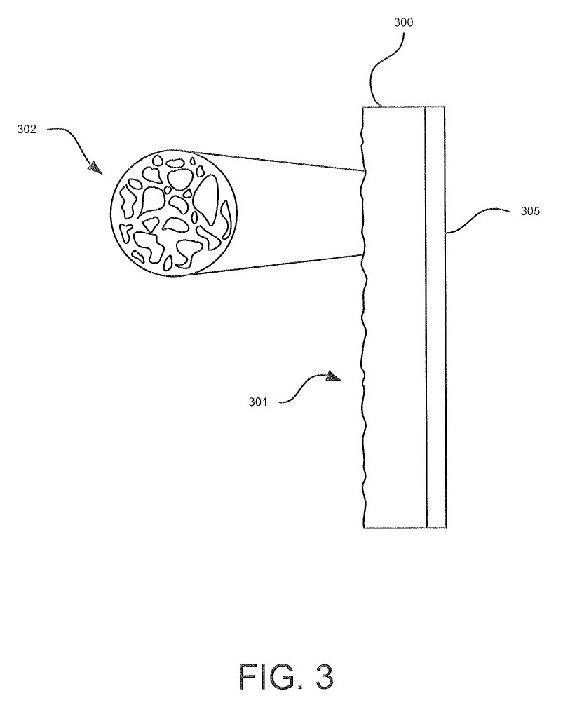

FIG. 3 is a cross-sectional view of one embodiment of a liner. The liner 300 is disposed on a face 305 and includes a treated surface 301. The topography 302 of the liner 300 may be seen in the close-up of FIG. 3. The liner 300 may be rigid or flexible. The liner 300 may be configured to be shaped to fit on a surface that is not completely flat. The liner 300 also may be configured to be disposed over movable parts. If the liner 300 is configured to bend, then the liner 300 also may be, for example, disposed over a corner. In such an embodiment, the liner 300 may have a curve of a particular radius.

The liner 300 may be composed of many different materials. Some specific examples may include, for example, KAPTON® (manufactured by DuPont), polyetheretherketone (PEEK™, manufactured by Victrex PLC), polytetrafluoroethylene (PTFE), perfluoroalkoxy or perfluoroalkoxyethylene (PFA), parylene, and UPILEX® (manufactured by Ube Industries). KAPTON® may include molecules with the formula C₂₂H₁₀N₂O₅ in some embodiments. Both KAPTON® and UPILEX® may be polyimides. In many embodiments, a liner 300 is composed of materials that will not harm or damage a workpiece, such as workpiece 138. For example, in some embodiments, a liner 300 is configured to have substantially low outgas in a vacuum to prevent contaminant production. Thus, the liner 300 also may be other polymers that are not listed above.

The treated surface 301 may be formed through corona treatment, plasma etching, chemical etching, bead blasting, mechanical treatment, chemical treatment, combinations thereof, or other methods of roughening. Many times, particles may flake or loosen from a smoother surface, so this treated surface 301, which, in this embodiment, includes roughening, is configured to increase surface area or to promote adhesion of particles. The roughened surface may allow the particles to grip the liner 300 better. Thus, the particles may not slide or fall off the liner 300. This better grip on the liner 300 by the particles due to the roughened surface also will reduce flaking off of any particles from the treated surface 301. The liner 300 also may prevent blistering of the face 305 due to implantation of atoms or ions such as hydrogen, helium, nitrogen, or oxygen. These atoms or ions may instead embed into the liner 300 or the treated surface 301 and eventually be evacuated from an ion implanter or plasma treatment system or removed with the liner 300 during maintenance.

The liner 300 may be configured to have specific temperature tolerances in some embodiments. This may depend on where in an ion implanter or plasma treatment device the liner 300 is disposed. However, temperature tolerance may not be a concern in other embodiments because of, for example, either where the liner 300 is disposed or because the liner 300 has a temperature tolerance to the whole range of operating temperatures within an ion implanter or plasma treatment device.

The liner 300 may be conductive in some embodiments. This conductive polymer is configured to prevent charge build-up upon the liner 300. In some embodiments, the conductive polymer may be doped to increase conductivity. Two examples of conductive polymers are polyetheretherketone (such as PEEK™, manufactured by Victrex PLC) and VESPEL® (manufactured by DuPont). VESPEL® may be a polyimide. Some filled polymers are made conductive by adding carbon or metals to the formulation. The amount of carbon or metal added to the filled polymer is configured to make the polymer conductive.

In another embodiment, the treated surface 301 of the liner 300 is hydrophilic to promote adhesion of particles. This hydrophilic surface may assist in retaining particles or deposits on the treated surface. In one specific embodiment, the hydrophilic surface is formed on a polymer liner, such as those listed above, for example. In two particular embodiments, the entire liner 300 is composed of hydrophilic material or the entire liner 300 is treated to be hydrophilic.

In other embodiments, the liner 300 is a filled polymer. This filled polymer is configured to prevent charge build-up upon the liner 300. The filled polymer may include fibers, particulates, or nanoparticles that prevent charge build-up. These fibers, particulates, or nanoparticles may be carbon or metals, for example. If the liner 300 is a filled polymer, it may be configured to not be an insulator to prevent arc discharge or to decrease ion beam blow-up.

In yet another embodiment, the liner 300 includes nanotubes. This may be one specific embodiment of a filled polymer. The nanotubes may be cylindrical carbon molecules that increase strength of the liner 300 and may be multi-wall carbon nanotubes (MWNT or MWCNT) or single-wall carbon nanotubes (SWNT or SWCNT). Thus, these nanotubes may be configured to stiffen the liner or make it more resistant to damage. The nanotubes also may be conductive to prevent charge build-up or be configured to conduct heat.

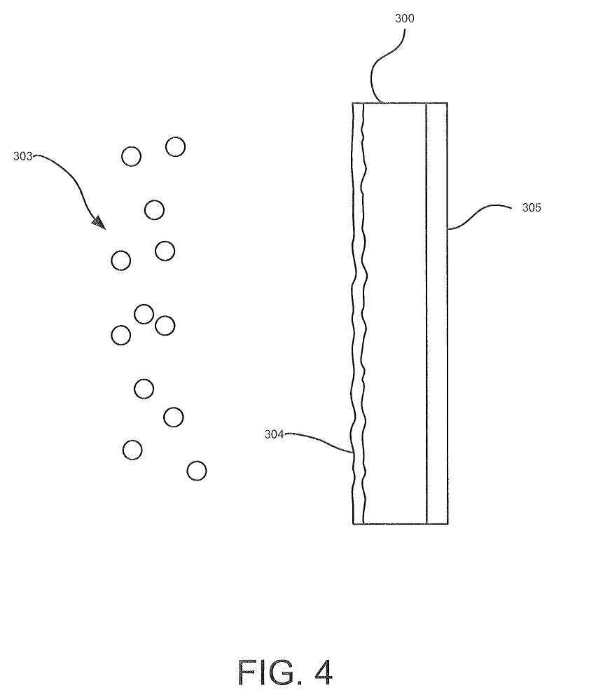

FIG. 4 is a cross-sectional view of an embodiment of the liner in FIG. 3 being impacted by particles. The liner 300 is disposed on a face 305 and is impacted by particles 303. Particles 303 are retained on the liner 300 to form a -film 304. The particles 303 can come from many sources. Particles 303 may be, for example, graphite, silicon from a workpiece, sputtered material, or implant byproducts such as photoresist. Particles 303 also may be other molecules or compounds that exist in a vacuum around the liner 300. Particles 303 also may be ions.

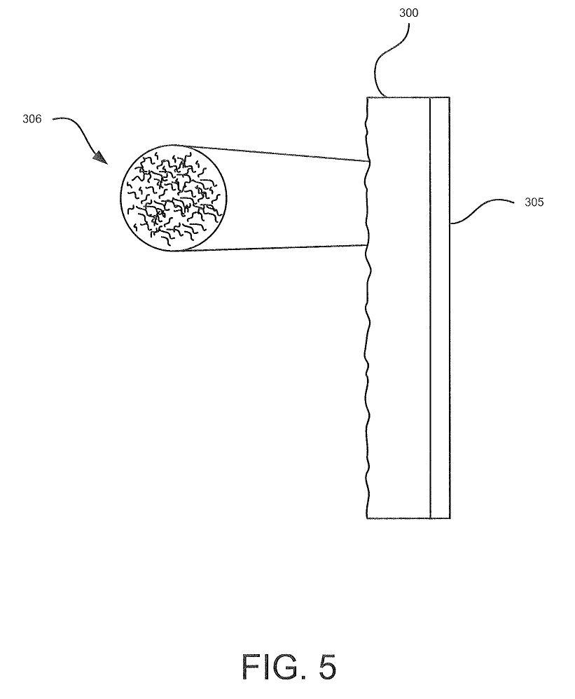

FIG. 5 is a cross-sectional view of another embodiment of a liner. This may be an alternative to the liner of FIG. 3. In this embodiment, the liner 300 is composed of carbon nanotubes 306. The liner 300 is disposed on a face 305 and includes carbon nanotubes 306, as seen in the close-up of FIG. 5. These carbon nanotubes 306 may be multi-wall carbon nanotubes (MWNT or MWCNT) or single-wall carbon nanotubes (SWNT or SWCNT). These carbon nanotubes 306 may be formed in a “nanosheet.” The liner 300 in one embodiment is composed of carbon nanotubes in a felt-like material. In alternate embodiments, the liner 300 is composed of carbon nanowires or other nano-sized objects. In another embodiment, the liner 300 is mounted on another layer that is then disposed on the face 305.

The liner 300 in the embodiment of FIG. 5 functions as a shield for parts in a plasma treatment device. The liner 300 may prevent blistering of the face 305 due to implantation of atoms or ions such as hydrogen, helium, nitrogen, or oxygen. If these atoms or ions are implanted under the surface of the face 305, small bubbles may form. This could cause blistering of the face 305. These atoms or ions may instead become embedded in the liner 300 and eventually be evacuated from an ion implanter or plasma treatment system or removed with the liner 300 during maintenance. The liner 300 in this embodiment also may promote adhesion of particles.

In another embodiment, the liner 300 is composed of a carbon-based material. The liner 300 in this particular embodiment may be porous and may be in the form of a sheet or block, cloth, felt, or foam. The liner 300 in this embodiment may include a treated surface. Some specific examples of this carbon-based material are a carbon weave, carbon cloth, carbon-carbon, carbon foam, carbon fibers, or carbon felt. The carbon fibers or carbon felt may be covered with SiC in some embodiments. In yet another example, the carbon-based material is graphite. The liner 300 in this particular embodiment also may prevent blistering of face 305 due to implantation of atoms or ions such as hydrogen, helium, nitrogen, or oxygen. These atoms or ions may instead flow into the liner 300 and eventually be evacuated from an ion implanter or a plasma treatment system or removed with the liner 300 during maintenance. The surface of the liner 300 may have an increased surface area to promote adhesion of particles. The increased surface area that promotes adhesion will also reduce flaking of any particles off of the treated surface 301.

Due to a condition or during preventative maintenance, liner 300 may be removed from the face 305. The condition may be an elapsed time, a change in ion species, or the state of the liner 300. In one particular embodiment, the liner 300 is configured to be rolled up once it is removed from the face 305 to reduce the amount of particles that contaminate an ion implanter during removal or preventative maintenance.

In other embodiments, the liner 300 remains disposed on a surface. During preventative maintenance, the liner 300 is cleaned to remove the film 304. This may be with, for example, clean wipes, chemicals, or scraping.

In some embodiments, the liner, such as liner 300, is configured to be cleaned once removed from the face 305 during preventative maintenance. This may be with, for example, clean wipes, chemicals, or scraping. After cleaning, it may be refastened to the face 305.

In another embodiment, the liner, such as liner 300, is configured to be disposable. Thus, once the liner 300 is removed from the face 305, it is disposed of and is replaced with a new liner. In any of these embodiments, the liner may be designed to be quickly removed and easily handled.

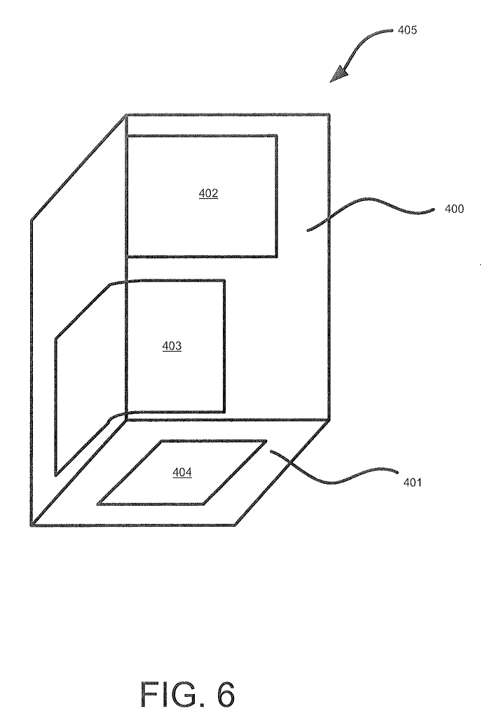

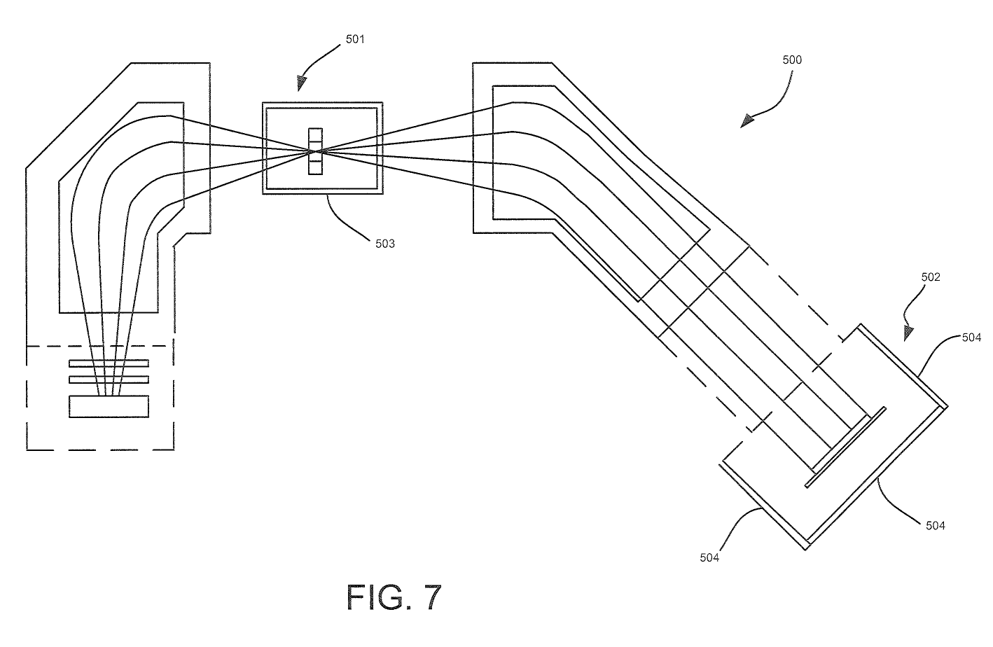

FIG. 6 is a cut-away perspective view of liners in a vacuum chamber. This is a three-dimensional view of a vacuum chamber 405 with walls 400 and a floor 401. The liners 402, 403, 404 are disposed on faces, such as, for example, the walls 400 and floor 401 of a vacuum chamber 405. As seen in FIG. 6, the liner 402 may abut a corner of the vacuum chamber 405 and the liner 403 may be stretched across the corner. Liners may be disposed on other faces within a vacuum chamber 405 or be other shapes or sizes than those illustrated in FIG. 6 as is known to those skilled in the art. FIG. 6 is merely an example of possible placement of liners 402, 403, 404. Some other possible examples of liner placement are illustrated in FIGS. 7-9. In other embodiments, the liners are disposed on faces within other plasma treatment devices known to those skilled in the art, such as on the walls or around the workpiece holding means.

The liners 402, 403, 404 are fitted on the walls 400 and floor 401 using screws in some embodiments. In other embodiments, the liners 402, 403, 404 are disposed on the walls 400 and floor 401 using pins. These pins may be nylon in some embodiments. In yet another embodiment, the liners 402, 403, 404 are disposed on the walls 400 and floor 401 using clips, a vacuum-tolerant adhesive with low outgas, double-sided sticky tape, gravity, or other fastening methods known to those skilled in the art.

FIG. 7 is a block diagram of liners in a beam-line ion implanter. Liners, such as liner 300, are located within beam-line ion implanter 500. The beam-line ion implanter 500 may correspond with the beam-line ion implanter 200 of FIG. 1. In some embodiments, liners 503 are located on faces within the resolving housing 501. In other embodiments, liners 504 are located on faces within the implant chamber 502. The implant chamber 502 may correspond to or be disposed within the end station 211.

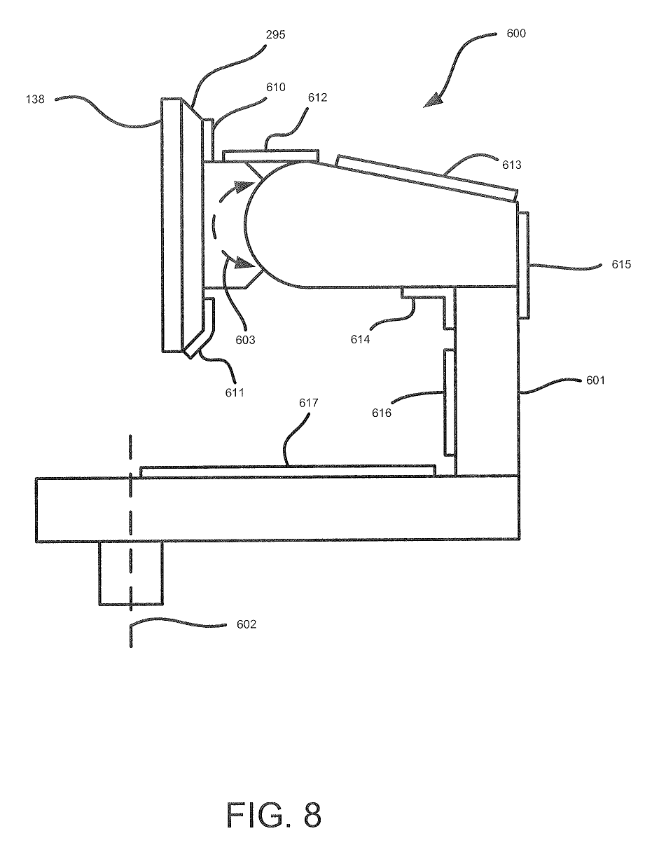

FIG. 8 is a cross-sectional view of an embodiment of liners on a workpiece holding apparatus. Workpiece holding apparatus 600 supports a platen 295 using a platen support 601. The platen 295 is configured to hold a workpiece 138. In this particular embodiment, the platen 295 is configured to tilt as indicated by the arrow 603, although the platen 295 may be tilted in other directions. The platen support 601 is also configured to rotate about the axis 602 in this particular embodiment. The workpiece holding apparatus 600 may include one or all of liners 610, 611, 612, 613, 614, 615, 616, and 617 on its faces. Those skilled in the art will recognize other places that a liner may be placed on the faces of the workpiece holding apparatus 600 or platen 295 and liners are not solely limited to the locations or sizes illustrated in FIG. 8. Liners disposed on a workpiece holding apparatus 600 or platen 295 may be specifically configured to collect silicon sputtered off the workpiece 138 during implantation in some embodiments.

Some of the liners, such as liners 611 and 614 may be configured to be disposed on different planes. One or more liners may fit in or over a corner or over an angle on different planes. Some of the liners, such as liner 612, may be configured to flex or be disposed over moving parts. For example, as the platen 295 tilts as indicated by arrow 603, the liner 612 flexes to remain disposed on the surface of the platen support 601 over the movable parts of the platen support 601. The liner may have excess material to accommodate any flexing in this embodiment. This may protect the inner parts, movable parts, or inner surfaces of the platen support 601 from any particles.

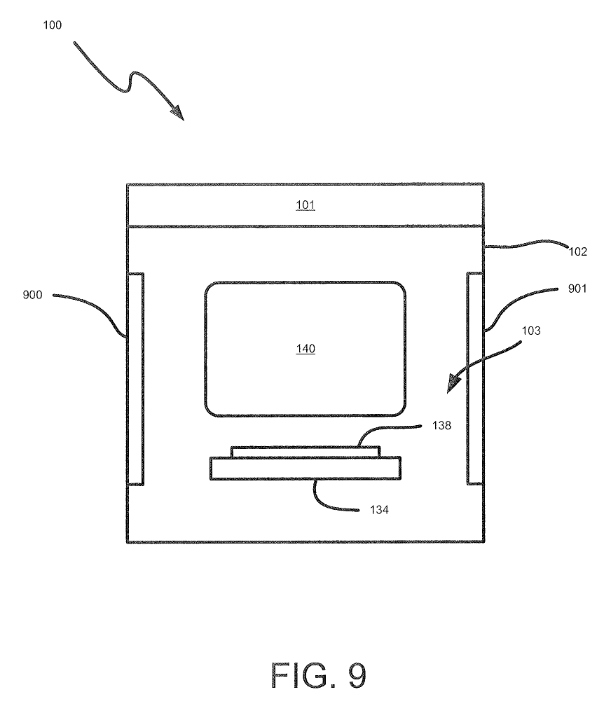

FIG. 9 is a block diagram of liners in a plasma doping system. The liners 900, 901 are located on faces of the process chamber 102 in the plasma doping system 100. Of course, the liners 900, 901 are not limited solely to the locations illustrated in FIG. 9 and the liners 900, 901 may be located elsewhere within the plasma doping system 100 as known to those skilled in the art, such as on or around the platen 134.

The present disclosure is not to be limited in scope by the specific embodiments described herein. Indeed, other various embodiments of and modifications to the present disclosure, in addition to those described herein, will be apparent to those of ordinary skill in the art from the foregoing description and accompanying drawings. Thus, such other embodiments and modifications are intended to fall within the scope of the present disclosure. Furthermore, although the present disclosure has been described herein in the context of a particular implementation in a particular environment for a particular purpose, those of ordinary skill in the art will recognize that its usefulness is not limited thereto and that the present disclosure may be beneficially implemented in any number of environments for any number of purposes. Accordingly, the claims set forth below should be construed in view of the full breadth and spirit of the present disclosure as described herein.

What is claimed is:

1. An apparatus comprising:
an ion generation device configured to generate ions;
a vacuum chamber;
a component in said vacuum chamber defining a face;
a workpiece;
a platen configured to support said workpiece for treatment by said ions; and
a liner disposed on said face to protect said workpiece from contamination, wherein said liner has a roughened surface and is selected from the group consisting of KAPTON, polyetheretherketone, polytetrafluoroethylene, perfluoroalkoxy, perfluoroalkoxyethylene, parylene, VESPEL, and UPILEX.

2. The apparatus of claim 1, wherein said roughened surface of said liner is made through at least one of corona treatment, plasma etching, chemical etching, bead blasting, mechanical treatment, and chemical treatment.

3. The apparatus of claim 1, wherein said liner is hydrophilic.

4. The apparatus of claim 1 further comprising a mass analyzer and a resolving aperture, and wherein said vacuum chamber comprises said resolving aperture and said face is a surface of said vacuum chamber.

5. The apparatus of claim 1, wherein said apparatus comprises a mass analyzer and a resolving aperture, and wherein said vacuum chamber is an implant chamber containing said platen and said face is a surface of said implant chamber.

6. The apparatus of claim 1, wherein said face is a surface defined by said platen.

7. The apparatus of claim 1, wherein said platen is disposed on a workpiece holding apparatus and said face is a surface defined by said workpiece holding apparatus.

8. The apparatus of claim 1, wherein said ion generation device is an ion source configured to generate said ions as an ion beam.

9. An apparatus comprising:
an ion generation device configured to generate ions;
a vacuum chamber;
a component in said vacuum chamber defining a face;
a workpiece;
a platen configured to support said workpiece for treatment by said ions; and
a liner disposed on said face, said liner composed of carbon and configured to prevent blistering of said face due to implantation of ions into said face.

10. The apparatus of claim 9, wherein said liner is composed of carbon nanotubes.

11. The apparatus of claim 9 further comprising a mass analyzer and a resolving aperture, and wherein said vacuum chamber comprises said resolving aperture and said face is a surface of said vacuum chamber.

12. The apparatus of claim 9, wherein said apparatus comprises a mass analyzer and a resolving aperture, and wherein said vacuum chamber is an implant chamber containing said platen and said face is a surface of said implant chamber.

13. The apparatus of claim 9, wherein said face is a surface defined by said platen.

14. The apparatus of claim 9, wherein said platen is disposed on a workpiece holding apparatus and said face is a surface defined by said workpiece holding apparatus.

15. The apparatus of claim 9, wherein said ion generation device is an ion source configured to generate said ions as an ion beam.

16. A method comprising:
providing a liner disposed on a face in a device configured to generate ions;
directing said ions toward a workpiece;
generating particles with said ions;
striking said liner with said particles; and
at least one of retaining said particles on said liner and preventing blistering of said face due to implantation of said particles.

17. The method of claim 16, wherein said liner has a roughened surface and said liner is selected from the group consisting of KAPTON, polyetheretherketone, polytetrafluoroethylene, perfluoroalkoxy, perfluoroalkoxyethylene, parylene, VESPEL, and UPILEX.

18. The method of claim 16, wherein said liner is composed of carbon nanotubes.

19. The method of claim 16, wherein said liner is composed of carbon.

20. The method of claim 16, wherein said method further comprises the step of removing said liner in response to a condition and positioning a second liner on said face.
